(19) United States
(12) Patent Application Publication
(10) Pub. No.: US 2009/0251504 A1
(43) Pub. Date: Oct. 8, 2009

(54) SYSTEMS AND METHODS FOR WET IN-SITU CALIBRATION USING MEASUREMENT OF LIGHT TRANSMITTANCE THROUGH INK DEPOSITED ON A SUBSTRATE

(75) Inventor: John M. White, Hayward, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/413,111

(22) Filed: Mar. 27, 2009

Related U.S. Application Data
(60) Provisional application No. 61/041,241, filed on Mar. 31, 2008.

(51) Int. Cl. B41J 29/38; B41J 29/393

(52) U.S. Cl. 347/14; 347/19

(57) ABSTRACT

The present invention provides inkjet print nozzle calibration systems and methods for measuring thickness of deposited ink pixel wells on a substrate. The method includes scanning a plurality of pixel wells with a thickness measurement device, wherein the pixel wells include fluid ink with evaporating solvent; re-scanning the plurality of pixel wells subsequent to the scanning; and determining an average thickness of the ink in each of the plurality of pixel wells based on measurements made during the scan and the re-scan. Numerous other aspects are provided.

### CROSS-REFERENCE TO RELATED APPLICATIONS

The present application claims priority to U.S. Provisional Patent Application No. 61/041,241, filed Mar. 31, 2008, and entitled “SYSTEMS AND METHODS FOR WET IN-SITU CALIBRATION USING MEASUREMENT OF LIGHT TRANSMITTANCE THROUGH INK DEPOSITED ON A SUSBTRATE” (Attorney Docket No. 12862/L), which is hereby incorporated herein by reference in its entirety for all purposes.

This application is also related to U.S. Provisional Patent Application Ser. No. 61/012,048, filed Dec. 6, 2007 and entitled “METHODS AND APPARATUS FOR MEASURING DEPOSITED INK IN A SUBSTRATE USING A LINE SCAN CAMERA” (Attorney Docket No. 12812/L), U.S. patent application Ser. No. 11/758,631 filed Jun. 5, 2007 and entitled “SYSTEMS AND METHODS FOR CALIBRATING INKJET PRINT HEAD NOZZLES USING LIGHT TRANSMITTANCE MEASURED THROUGH DEPOSITED INK” (Attorney Docket No. 11129), U.S. Patent Application Ser. No. 61/012,052, filed Dec. 6, 2007, and entitled “SYSTEMS AND METHODS FOR IMPROVING MEASUREMENT OF LIGHT TRANSMITTANCE THROUGH INK DEPOSITED ON A SUBSTRATE” (Attorney Docket No. 12767). These patent applications are also hereby incorporated by reference herein in their entirety.

### FIELD OF THE INVENTION

The present invention relates generally to inkjet printing of color filters for flat panel displays and more particularly to systems and methods for wet in-situ calibration using measurement of light transmittance through ink deposited on a substrate.

### BACKGROUND OF THE INVENTION

Displays such as those used in flat panel displays typically include a matrix of pixels on a substrate that are selectively illuminated to form images. The pixels may be formed from ink wells with ink deposited therein. The ink deposited in the ink wells functions as a color filter that is used to display images. The amount of ink deposited in the ink wells can affect the appearance of the display. Thus, to achieve the desired appearance, a precise amount of ink is preferably deposited in the ink wells.

Conventionally, different methods are used to determine whether nozzles are accurately depositing precise amounts of ink. For example, test patterns are printed, and the test patterns are compared to an intended pattern, as described, e.g., in US Patent Publication 2006/0119633, entitled “METHOD OF CALIBRATING INKJET PRINT HEAD,”; sensors sense the landing position of the ink and compare it to the relative position of a reference ink drop, as described, e.g., in U.S. Pat. No. 6,227,644, entitled “INKJET DOT IMAGING SENSOR FOR THE CALIBRATION OF INKJET PRINT HEADS.” However, both of these methods may take time with respect to performing the test and comparing the test results and performing complicated computations. Therefore, more efficient methods and apparatus for calibrating inkjet print heads and making adjustments to printing parameters are desirable.

### SUMMARY OF THE INVENTION

In an aspect of the present invention, a method for measuring thickness of deposited ink in pixel wells on a substrate is provided. The method includes scanning a plurality of pixel wells with a thickness measurement device, wherein the pixel wells include fluid ink with evaporating solvent; re-scanning the plurality of pixel wells subsequent to the scanning; and determining an average thickness of the ink in each of the plurality of pixel wells based on measurements made during the scan and the re-scan.

In another aspect of the present invention, a system for measuring thickness of ink deposited in pixel wells on a substrate is provided. The system includes a light source adapted to transmit light through a plurality of pixel wells on a substrate, the pixel wells including fluid ink with evaporating solvent; an optical detection device adapted to scan and re-scan ink drying in the plurality of pixel wells and to receive the transmitted light; and a processor adapted to determine an average thickness of the ink in each of the plurality of pixel wells based on the scan and re-scan.

In yet another aspect of the present invention, method for measuring thickness of ink deposited in pixel wells on a substrate and determining whether an ink-jetting nozzle is properly calibrated is provided. The method comprises scanning a plurality of pixel wells, the pixel wells including fluid ink with evaporating solvent, with a thickness measurement device; re-scanning the plurality of pixel wells subsequent to the scanning with the thickness measurement device; determining an average thickness of the ink in each of the plurality of pixel wells based on measurements made during the scan and re-scan; comparing the average thickness of ink in each pixel well to an intended ink volume to determine a variation between the average thickness of ink in each pixel well and the intended ink volume; and identifying pixel wells with a variation that exceeds a threshold value.

Other features and aspects of the present invention will become more fully apparent from the following detailed description, the appended claims, and the accompanying drawings.

### SUMMARY OF THE DRAWINGS

FIG. 1 is a graph depicting the drying effect according to the present invention.

FIG. 2 is a schematic diagram of an inkjet print nozzle calibration system in accordance with embodiments of the present invention.

FIG. 3A is a flowchart depicting an example application method of embodiments of the present invention.

FIG. 3B is a graph depicting the use of scan averaging to compensate for the drying effect according to the present invention.

FIG. 3C is a flowchart depicting an example application method of embodiments of the present invention.

FIG. 3D is a graph depicting the use of scan averaging to compensate for the drying effect according to the present invention.

FIG. 4 is a flowchart depicting an example application method of embodiments of the present invention.

### DETAILED DESCRIPTION

Measurement devices, including high resolution digital line scan cameras, CCD-based cameras, and/or any other suitable cameras may be used to measure the amount of light transmitted through a pixel well. Light transmittance measurements may be used to determine the thickness of ink deposited in a pixel well. The amount of ink in a pixel well may be directly related to the amount of light that passes through the filled pixel well relative to an empty pixel well. Thus, by measuring the amount of light that comes through a filled pixel well of a known size, the volume of ink in the pixel well may be determined. However, as solvent evaporates from the ink (e.g., as the ink dries), the volume or thickness of ink in the pixel well decreases, giving the appearance that less ink was jetted into the pixel well than was actually jetted. When the ink contains more solvent, less light may be detected by the measurement device. This may be the result of, for example, an optical or other lensing effect in which the greater the amount of solvent in the ink, the more light is dispersed, and hence less light is detected; or it may be the result of, for example, the change in the relative concentration of pigment relative to the amount of solvent; or it may be due to other factors. As described above, a measurement device, such as a camera, for example, may be used to scan the light transmitted through the ink in each column of pixel wells.

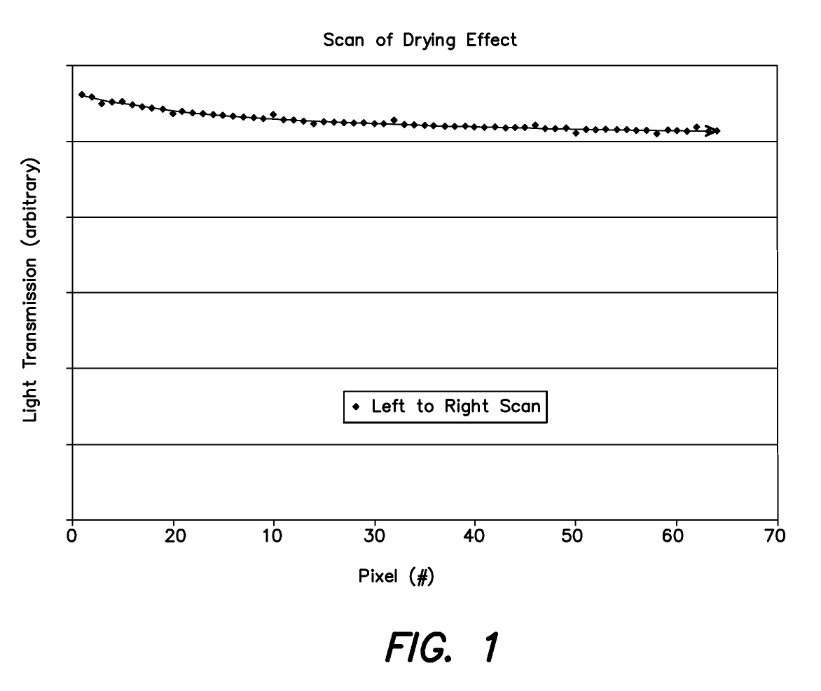

However, the time it takes to scan each successive column of pixel wells across a substrate results in changes in the apparent thickness/volume of the ink in each column of pixel wells, due to the evaporation of the solvent. In other words, in the time it takes to scan a whole row of ink filled pixel well columns, for example, the scanning of the first pixel well columns may indicate more solvent than the later scanning of the last pixel well columns because by the time the last pixel well columns are scanned, more of the solvent has evaporated (FIG. 1). These variations in the volume of ink determined based on the measured light transmittance in the pixel well columns may therefore be the result of ink drying, and not the result of an improperly calibrated nozzle.

In conventional systems, variations in nozzle calibration may not be evident until the printing operations have been completed, the ink has dried, and the substrate has been removed from the printer. In the present invention, on the other hand, the nozzles may be calibrated during printing operations immediately within the printer (i.e., in-situ) so that any potential problems may be addressed before the entire substrate is printed, and the costs associated with waiting for the ink to dry, removing the substrate from the printer, and/or reprinting are incurred.

To calibrate the nozzles, the present invention provides methods for more accurately measuring the volume/thickness of ink in a pixel well column jetted by a nozzle of an inkjet print head during printing operations, by compensating for the relative differences in the measurement of ink thickness resulting from the evaporation of the solvent component of the ink when scanning many columns of pixels over time. To more accurately determine whether an intended amount of ink was jetted by a particular nozzle into a column of pixel wells, in some embodiments a standard for comparison may first be determined. The print head may include 128 nozzles, and to determine the standard, each nozzle may jet ink into a corresponding pixel column, such that 128 pixel columns receive ink from 128 nozzles. Then, a camera may scan the 128 pixel wells containing ink in a first direction, and then in the opposite direction, using measured light transmittance, to determine ink thickness. The scanning may be done in the printer during printing (in situ) immediately after jetting while the ink is still drying, e.g., solvent is still evaporating from the ink. The average ink thickness across the 128 pixel columns may be the standard. Then, the measured thickness of the ink jetted by each nozzle may individually be compared to the standard to determine whether the individual nozzle is properly calibrated. To obtain the measured thickness of the ink jetted by each nozzle, each nozzle may jet ink into a column of pixel wells. It should be noted that typically there are more pixel well columns than nozzles, therefore an individual nozzle may jet ink into more than one column of pixel wells. The columns filled by an individual nozzle may be scanned by the camera in a first direction, and then in the opposite direction, using measured light transmittance to determine ink thickness. For each nozzle, the measured ink thicknesses from the first and second scans may then be averaged. This average may then be compared to the standard. If the variation between the average ink thickness jetted by an individual nozzle and the standard is above or below a particular threshold value, the nozzle jetting the ink may need to be calibrated, such that a consistent height, width, and/or drop size of ink may be achieved. The process for obtaining the measured thickness of the ink jetted by each nozzle may be repeated, for example, for two to four cycles, until all of the nozzles are adjusted to jet the same amount of ink into each pixel.

In an alternate embodiment, nozzle calibration may be achieved differently. For example, a camera may scan the ink jetted by a particular nozzle in a row of pixel well columns in a first direction using light transmittance. As above, this may be done in the printer during printing (in situ), immediately after jetting while the ink is still drying, e.g., solvent is still evaporating from the ink. The camera may then scan the ink in the same pixel wells in the opposite direction, also using measured light transmittance to determine ink thickness. The light transmittance information from the first and second scans may then be averaged. This average may be referred to as a first measured average. The first measured average may then be compared to an intended or desired amount of jetted ink. The intended or desired amount of jetted ink may be determined, for example, by the type of printing processes being performed, manufacturer instructions or client needs. If the variation between the first measured average and the intended amount is above or below a particular threshold value, the nozzle jetting the ink may need to be calibrated, such that a consistent height, width, and/or drop size of ink may be achieved.

The present invention may allow for improved thickness measurement accuracy by compensating for the relative differences in the measurement of ink thickness resulting from the evaporation of the solvent component of the ink when scanning many pixels over time. The increased accuracy may also allow for a more efficient and increased throughput as less time may be used to determine whether the nozzles are calibrated correctly.

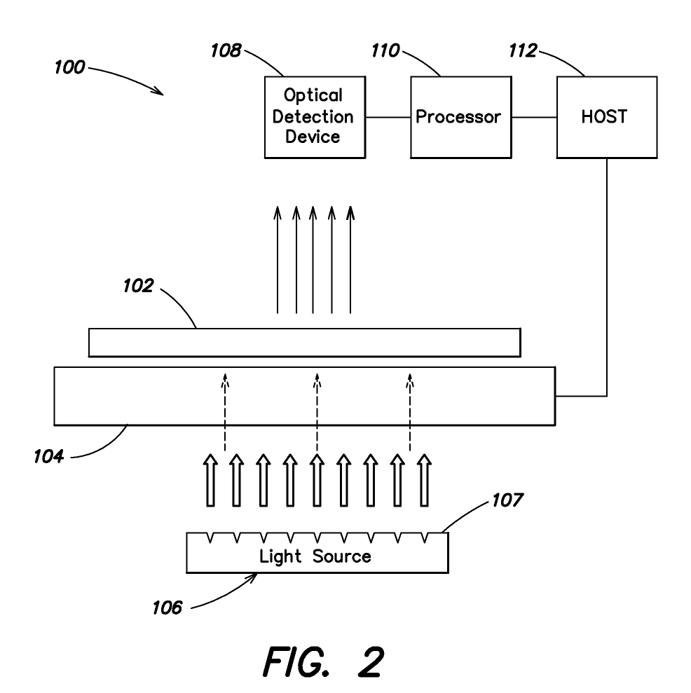

Turning to FIG. 2, a schematic diagram of an example inkjet print nozzle calibration system 100 according to the present invention which uses light transmittance to determine the volume of ink that has been dispensed within a color filter display pixel located on a substrate is provided.

As shown, a substrate 102, which may be a flat panel made of glass, polymer, etc., is positioned on a supporting stage 104. The substrate 102 may include a black matrix material including pixel wells arranged in rows and columns over the surface of the substrate. The pixel wells are used to hold ink dispensed from ink jet print heads (not shown). Each of the pixels may have the same length and width dimensions (the actual length and width of a given pixel may be different) and thus each of the pixels in the matrix on the substrate 102 may be adapted to hold a similar volume of ink. Example embodiments of the black matrix and pixel wells that may be used in the context of the present invention are described in previously incorporated U.S. patent application Ser. Nos. 11/521,577 and 11/536,540.

The supporting stage 104 may include a moving platform adapted to transport the substrate in a Y-direction (in a direction into or out of the page in FIG. 2) below one or more print heads positioned over the stage 104 which may dispense ink into the pixel wells of the substrate 102. In color filter printing, typically a single color (e.g., red, green or blue) is dispensed into the pixels of a given column on the substrate 102 while a different color is dispensed into adjacent columns. In such procedures, color mixing is generally avoided. Various aspects of the support stage 104 and print head arrangements that may be used in ink jet printing procedures in the context of the present invention are described in previously incorporated U.S. Provisional Patent Application No. 60/785,594. The supporting stage 104 may include orifices, holes, gaps, windows, slits, and the like (not shown) that extend through an entire thickness of the stage 104, such that the substrate 102 may be exposed to light emanating from under the supporting stage 104.

A light source 106 may be positioned beneath the supporting stage 104 so as to transmit light via orifices, holes, gaps, windows, slits, etc. in the supporting stage 104 and thus illuminate the pixel ink wells on the substrate 102. The light source may comprise, for example, a Phlox 4i-BL Series Backlight provided by Leutron Vision of Burlington, Mass. The 4i-BL Series Backlight light source 106 may include light pipes comprising translucent materials adapted to guide light in a particular direction. The light pipes may be configured such that a substantial proportion of light introduced into the backlight light source 106 (e.g., via LEDs coupled to sides of the backlight) is reemitted uniformly from the top surface 107 of the backlight light source 106. The surface area of the light source 106 may be chosen depending on the size of the substrate 102, and may vary from 20×20 mm to 200×200 mm, for example. Other dimensions may be used. The luminance of the light source 106 may range from approximately 4,000 to 20,000 cd/m² (candelas per square meter), in inverse proportion to the surface area. The light source 106 may emit white light to provide transmittance through different color inks. In some embodiments, multiple light sources may be used to illuminate the substrate 102. In some embodiments, collimating devices and filters may be employed to make the light from the light source 106 more uniform and consistent. In some embodiments, the light source 106 may be moved along with the optical detection device 108 to provide a consistent and uniform supply of light.

An optical detection device 108 adapted to measure light transmittance may be positioned so as to capture light transmitted from the light source 106 through the pixel wells of the substrate 102. The optical detection device 108 may comprise, for example, a charge coupled device (CCD) camera.

A suitable CCD camera that may be used in the context of the present invention, may include, for example, a 7 um pixel size or smaller, a 2000 pixel count or greater, and an intensity accuracy of 0.1%, and a 1×1 lens. Cameras with other dimensions and parameters may be used. The optical detection device 108 may be mounted on a support or other feature (not shown) above the supporting stage 104 in an ink jet printing system. As noted, the magnitude of light captured from a particular pixel location on the substrate 102 is proportional to the transmittance of the pixel location, and inversely proportional to the thickness (and volume) of the ink at the pixel location through which the captured light is transmitted. The optical detection device 108 may be movable in the X and/or Y-axis directions using, for example, one or more motors (not shown). As indicated above, in some embodiments, the light source 106 may be moved with, and/or linked to, the optical detection device 108.

The system 100 may further include an image processor 110 which may comprise a computing device, and may be coupled to the optical detection device 108 to acquire image data (which includes the transmittance information.) A host computer 112 (e.g., a UNIX host) may be coupled to the image processor 110 via, e.g., an Ethernet or an RS232 connection, for example. The host computer 112 may comprise a system controller and/or data server for an ink jet printing system. In one or more embodiments, the image processor 110 and the host computer 112 may be combined. The host computer 112 may be operatively coupled to the light source 106 so as to control the operation of the light source 106 (e.g., activate or de-activate the light source 106, adjust illumination, etc.). In one or more embodiments, the host computer 112 may activate the light source 106 without any delay or start-up time.

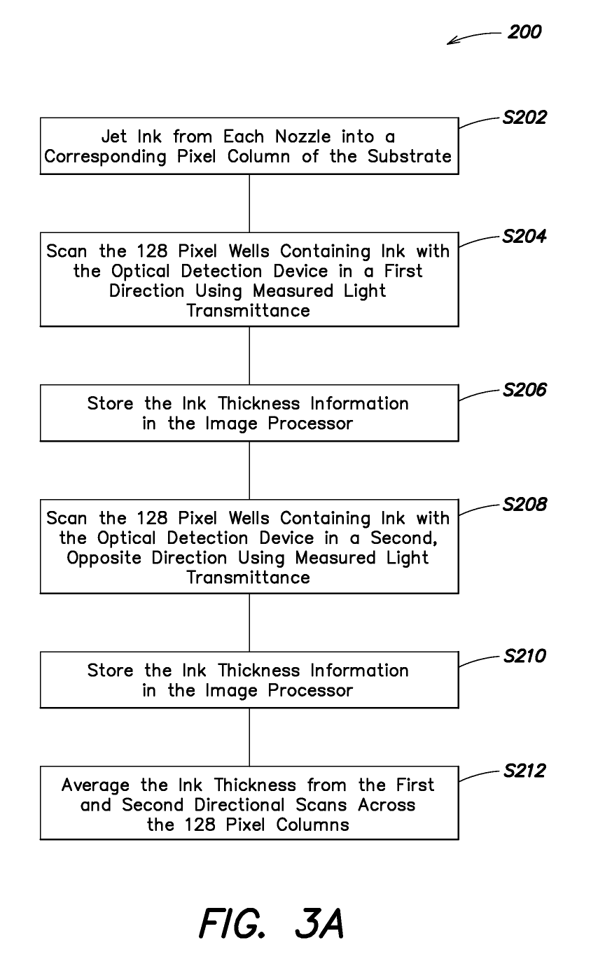

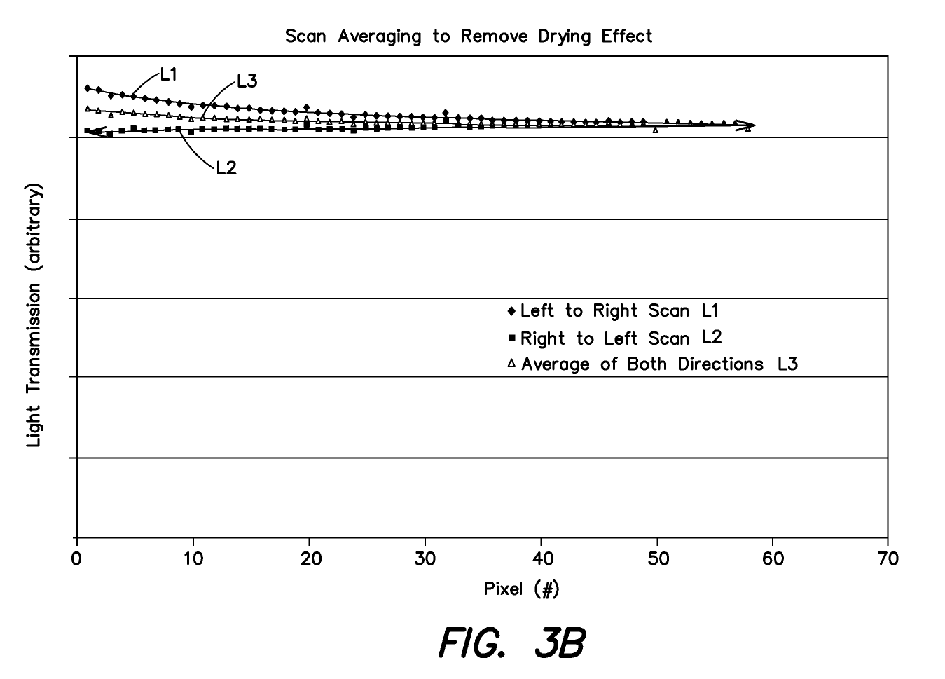

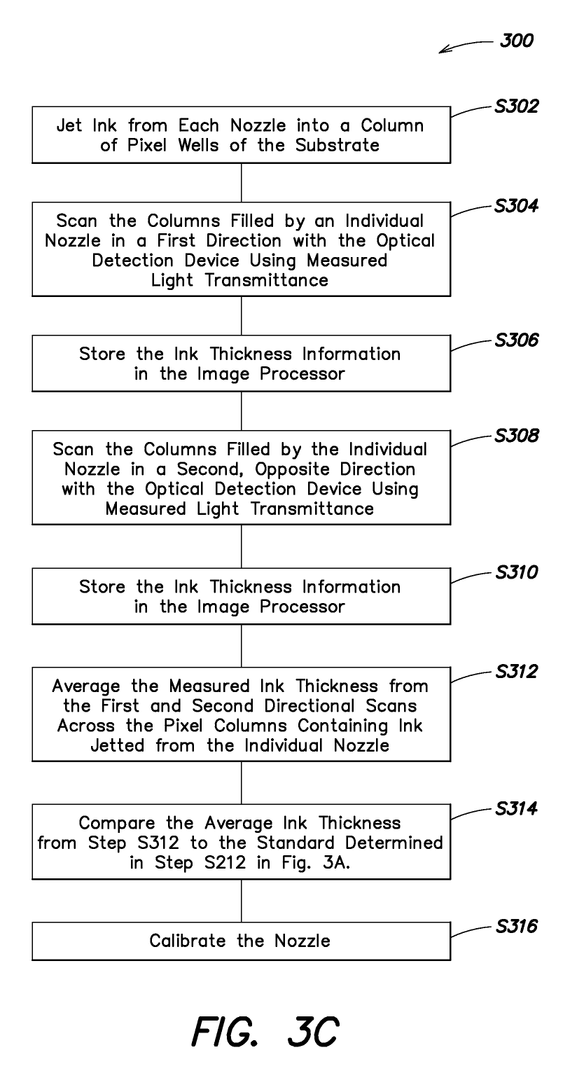

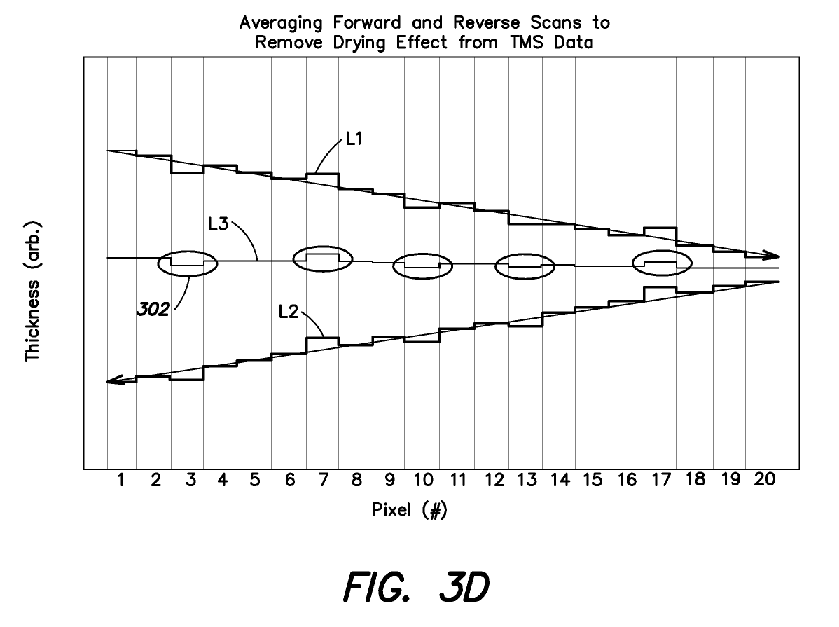

Turning to FIG. 3A, a flowchart illustrating an example method 200 for more accurately measuring the volume/thickness of ink in a pixel well column is provided in accordance with an embodiment of the present invention. A standard of comparison may first be determined. As described above, the print head may include 128 nozzles. In step S202, to determine the standard, each nozzle may jet ink into a corresponding pixel column of the substrate 102, such that 128 pixel columns may receive ink from 128 nozzles. Then in step S204, the optical detection device 108 (e.g., a camera) may scan the 128 pixel wells containing ink in a first direction using measured light transmittance. The ink thickness information from the first directional scan may be stored in the image processor 110 in step S206. The optical detection device 108 may scan, or re-scan, the 128 pixel wells containing ink in a second, opposite direction in step S208, again using measured light transmittance. The ink thickness information from the second, opposite directional scan may be stored in the image processor 110 in step S210. The re-scan may occur right after, or close in time to the scan. As indicated above, the scanning may be done in the printer during printing (in situ) immediately after jetting the ink while the ink is still drying, e.g., solvent is still evaporating from the ink. Then in step S212, the processor 110 or host computer 112 may average the ink thickness from the first and second directional scans across the 128 pixel columns. The average ink thickness is the standard, which may be used for comparison. The average ink thickness may be referred to as “standard thickness.”

As indicated in FIGS. 3B and 3D, line 1 (L1) is the first directional scan (also shown in FIG. 1), and line 2 (L2) is the second, opposite directional scan. The general downward trends of L1 and L2 may be due to the “drying effect,” or solvent evaporation. Line 3 (L3) represents the average of L1 and L2. L3 indicates that the averaged thickness value may be much closer to a “true” horizontal, indicating a similar ink thickness/volume for the pixel wells, than the values from the individual scans. By averaging the first and second scans, the “drying effect,” may be largely removed. It should be noted that with regards to the “drying effect,” if the effect is not sufficiently linear with time, the thickness for the first and last pixel wells may not be calibrated to the same thickness. Therefore, it may be desirable to compensate for the non-linearity by creating a camera scanning velocity profile that mimics the drying effect or, once the data has been captured, processing the data to “flatten” the average curve or linearize the raw data, for example. Other non-linear compensatory means may be used.

Turning to FIG. 3C, a flowchart illustrating an example method 300 to determine whether an individual nozzle is properly calibrated is provided in accordance with an embodiment of the present invention. In step S302, each nozzle may jet ink into a column of pixel wells of the substrate 102. As indicated above, it should be noted that typically there are more pixel well columns than nozzles, therefore an individual nozzle may jet ink into more than one column of pixel wells. In step S304, the columns filled by an individual nozzle may be scanned by the optical detection device 108 in a first direction using measured light transmittance. The ink thickness information from the first directional scan may be stored in the image processor 110 in step S306. The optical detection device 108 may scan the columns filled by the individual nozzle in a second, opposite direction in step S308, again using measured light transmittance. The ink thickness information from the second, opposite directional scan may be stored in the image processor 110 in step S310. Then in step S312, the processor 110 or host computer 112 may average the measured ink thickness from the first and second directional scans across the pixel columns containing ink jetted from the individual nozzle. In step S314, the host computer 112 may compare the average ink thickness from step S312 to the standard, determined in step S212 in FIG. 3A. If the comparison indicates a variation above or below a particular threshold value, the nozzle is calibrated in step S316, such that a consistent height, width, and/or drop size of ink may be achieved. For example, as shown in FIG. 3D, the ovals 302 indicate pixels containing ink from an un-calibrated nozzle. The process for obtaining the measured thickness of the ink jetted by each nozzle may be repeated, for example, for two to four cycles, until all of the nozzles are adjusted to jet the same amount of ink into each pixel, or until each nozzle is calibrated within an acceptable tolerance.

In some embodiments, the processor 110 or host computer 112 may use the data from the standard computation to determine whether the nozzles were properly calibrated. In other words, the ink thickness measurements from the initial scan and rescan for the ink deposited in each pixel well may be stored. After the standard thickness average is computed, the measured ink thickness for each pixel well that was used to compute the average, may be compared to the average to determine whether the nozzle jetting the ink into each pixel well is properly calibrated.

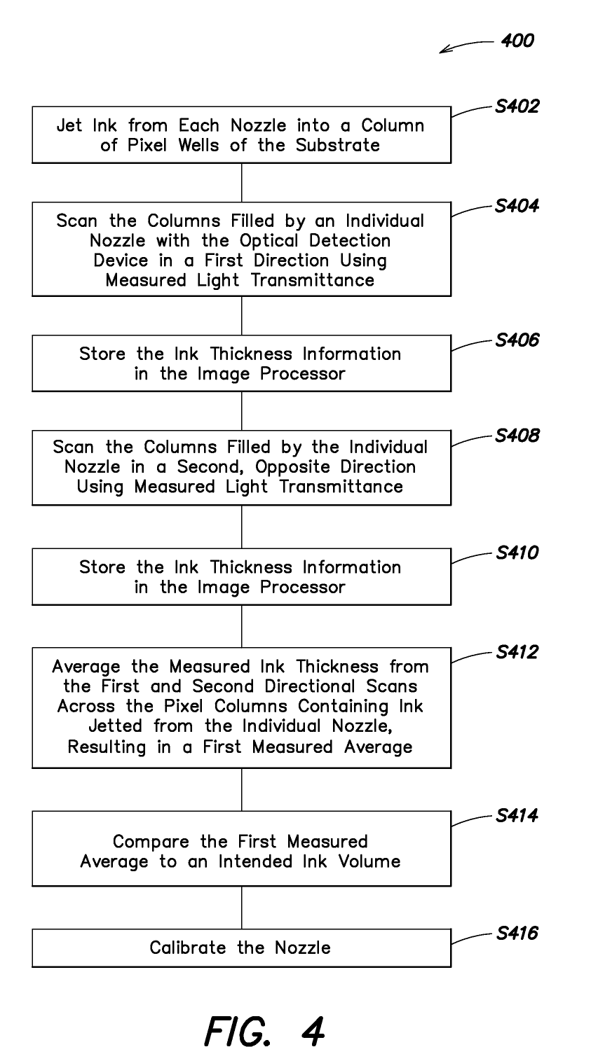

Turning to FIG. 4, a flowchart illustrating another example method 400 to determine whether an individual nozzle is properly calibrated is provided in accordance with an embodiment of the present invention. In step S402, each nozzle may jet ink into a column of pixel wells of the substrate 102. In step S404, the columns filled by an individual nozzle may be scanned by the optical detection device 108 in a first direction using measured light transmittance. The ink thickness information from the first directional scan may be stored in the image processor 110 in step S406. The optical detection device 108 may scan the columns filled by the individual nozzle in a second, opposite direction in step S408, again using measured light transmittance. The ink thickness information from the second, opposite directional scan may be stored in the image processor 110 in step S410. Then in step S412, the processor 110 or host computer 112 may average the measured ink thickness from the first and second directional scans across the pixel columns containing ink jetted from the individual nozzle. The average of the first and second scans may be referred to as a first measured average.

The first measured average is compared to an intended ink volume in step S414. The intended or desired amount of jetted ink may be determined, for example, by the type of printing processes being performed, manufacturer instructions or client needs. If the comparison indicates a variation above or below a particular threshold value, the nozzle is calibrated in step S416, such that a consistent height, width, and/or drop size of ink may be achieved. The process for obtaining the measured thickness of the ink jetted by each nozzle may be repeated, for example, for two to four cycles, until all of the nozzles are adjusted to jet the same amount of ink into each pixel.

The foregoing description discloses only particular embodiments of the invention; modifications of the above disclosed methods and apparatus which fall within the scope of the invention will be readily apparent to those of ordinary skill in the art. For example, this invention could be applied to filters for organic light emitting diode (OLED) panels, as well as flat panel displays.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

1. A method for measuring thickness of deposited ink in pixel wells on a substrate, the method comprising:
scanning a plurality of pixel wells with a thickness measurement device, wherein the pixel wells include fluid ink with evaporating solvent;
re-scanning the plurality of pixel wells subsequent to the scanning; and
determining an average thickness of the ink in each of the plurality of pixel wells based on measurements made during the scan and the re-scan.

2. The method of claim 1 further comprising:
comparing the average thickness of ink in each pixel well to a standard thickness to determine a variation between the average thickness of ink in each pixel well and the standard thickness; and
identifying pixel wells with a variation that exceeds a threshold value.

3. The method of claim 2 further comprising:
identifying an ink-jetting nozzle for calibration based on the identified variation associated with the pixel well filled by the ink-jetting nozzle.

4. The method of claim 2 further comprising:
calibrating the ink-jetting nozzle based on the variation between the standard thickness and the average thickness of the ink.

5. The method of claim 1 further comprising:
comparing the average thickness of ink in each pixel well to a standard thickness to determine a variation between the average thickness of ink in each pixel well and the standard thickness; and
determining an ink-jetting nozzle is calibrated within an acceptable tolerance based on the variation between the standard thickness and the average thickness of ink.

6. The method of claim 1 further comprising:
determining the standard thickness prior to scanning the plurality of pixel wells with the thickness measurement device.

7. The method of claim 1 further comprising:
jetting ink into the plurality of pixel wells prior to scanning and re-scanning the plurality of pixel wells.

8. The method of claim 7 wherein the determination of the average thickness of ink in the plurality of pixel wells is based on ink jetted from a single nozzle in a print head.

9. The method of claim 1 wherein the thickness measurement device includes:
a light source adapted to transmit light through the plurality of pixel wells; and
an optical detection device adapted to perform the scanning and re-scanning.

10. The method of claim 1 further comprising:
storing results of the scan and re-scan in an image processor.

11. The method of claim 1 further comprising:
computing the standard thickness as an average of the thickness of ink in all of the plurality of pixel wells.

12. A system for measuring thickness of ink deposited in pixel wells on a substrate comprising:
a light source adapted to transmit light through a plurality of pixel wells on a substrate, the pixel wells including fluid ink with evaporating solvent;
an optical detection device adapted to scan and re-scan ink drying in the plurality of pixel wells and to receive the transmitted light; and
a processor adapted to determine an average thickness of the ink in each of the plurality of pixel wells based on the scan and re-scan.

13. The system of claim 12 further comprising:
a supporting stage adapted to support the substrate.

14. The system of claim 13 wherein the supporting stage includes one or more orifices adapted to allow the transmittance of light from the light source.

15. The system of claim 13 wherein the light source is adapted to move with the optical detection device.

16. A method for measuring thickness of ink deposited in pixel wells on a substrate and determining whether an ink-jetting nozzle is properly calibrated comprising:
scanning a plurality of pixel wells with a thickness measurement device, wherein the pixel wells include fluid ink with evaporating solvent;
re-scanning the plurality of pixel wells subsequent to the scanning;
determining an average thickness of the ink in each of the plurality of pixel wells based on measurements made during the scan and re-scan;
comparing the average thickness of ink in each pixel well to an intended ink volume to determine a variation between the average thickness of ink in each pixel well and the intended ink volume; and
identifying pixel wells with a variation that exceeds a threshold value.

17. The method of claim 16 further comprising:
determining the intended ink volume based on at least one of type of printing process, manufacturer instructions, and user needs.

18. The method of claim 16 further comprising:
identifying ink-jetting nozzles to be calibrated based on the identified variation associated with the pixel wells filled by the ink-jetting nozzles.

19. The method of claim 15 further comprising:
calibrating an ink-jetting nozzle based on the variation between the intended ink volume and the average thickness of ink.

20. The method of claim 15 further comprising:
providing a light source to transmit light through the plurality of columns of ink-containing pixel wells.
